(19) United States
(12) Patent Application Publication
(10) Pub. No.: US 2003/0073405 A1
(43) Pub. Date: Apr. 17, 2003

(54) Radio signal relay

(75) Inventor: Tonny Chen, Chang-Hua (TW)

Correspondence Address: DOUGHERTY & TROXELL, SUITE 1404, 5205 LEESBURG PIKE, FALLS CHURCH, VA, 22041, US

(73) Assignee: E-Lead Electronic Co., Ltd.

(21) Appl. No.: 09/978,008

(22) Filed: Oct. 17, 2001

(51) Int. Cl. H04B 7/14

(52) U.S. Cl. 455/18; 455/7

(57) ABSTRACT

A radio signal relay for extending effective transmission distance of radio signals consists of a receiver and transmitter, a signal processing unit, an input output bus unit, a processing unit, a memory unit, a signal amplification unit and an antenna. The radio signal relay is adaptable for use in transmission modules of telephones, information peripherals, modem transmission and the like to extend the effective radio transmission distance.

### BACKGROUND OF THE INVENTION

1. Field of the Invention

The invention relates to a radio signal relay and particularly a relay for extending effective transmission distance of radio signals and integrating radio signals for various communication and business equipment and extending their effective transmission distances.

2. Description of the Prior Art

The rapid technology innovations in electronics have spawned many new business products and opportunities, electronic business is one of them that has attracted a lot of attention and investments. These days, in communication and business equipment such as mobile phones, Personal Digital Assistant (PDA), computer peripheral devices, adopting short distance radio signal transmission for information receiving and transmitting has become increasingly popular. Whereas the technology of short distance radio signal transmission has a major bottleneck and drawback, i.e. it has limited effective transmission distance. To resolve this problem, in the past users are requested to use radio signal control or data transmission within the effective transmission boundary. This approach cannot meet users' requirements. It only overcomes the line connection or workstation linking problems. It still does not truly achieve the object of radio signal transmission. For instance, when using radio signal transmission to transmit printing commands to printers, users have to go the printers to check if the printers have received the commands. After printing is completed, users have to go to the printers again to take the documents. Such kind of wireless function has little value and is not well accepted.

### SUMMARY OF THE INVENTION

In view of aforesaid disadvantages, it is therefore a primary object of the invention to provide a radio signal relay to overcome the distance limitation of radio signal transmission that incurs to communication or business equipment and to extend the effective transmission distance, and to integrate different radio transmission signals to further extend the effective transmission distance.

The invention mainly deploys the relays at selected critical locations for extending the effective radio signal transmission distance and integrating different radio signals to further extend the effective transmission distance. The invention is adaptable for use in radio transmission modules for various communication or business equipment such as telephones, information peripherals, modem transmission, and the like.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a system block diagram of the invention.

FIG. 2 is an operation flowchart of the invention.

### DESCRIPTION OF THE PREFERRED EMBODIMENT

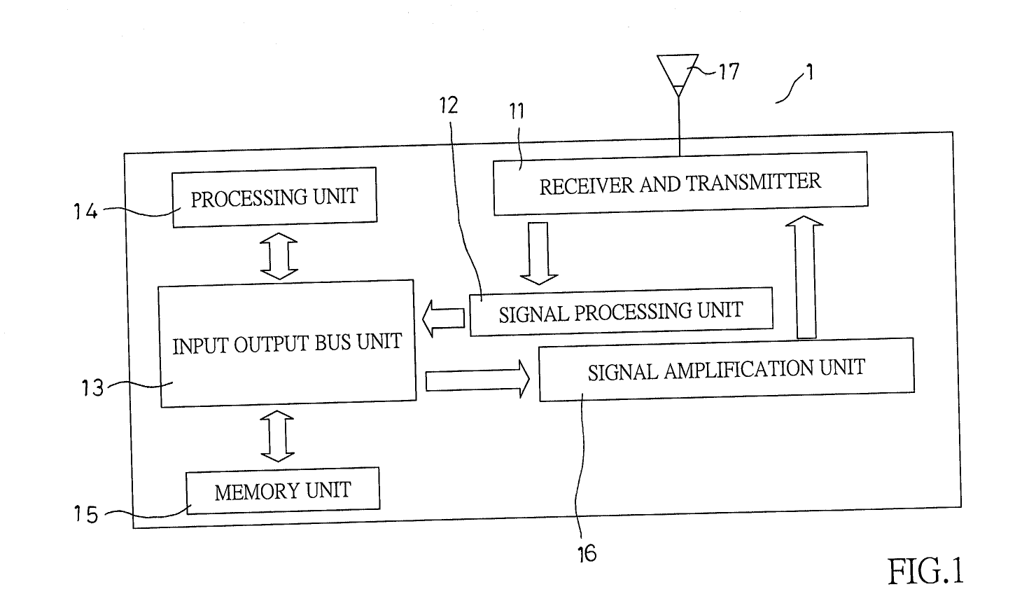

Referring to FIG. 1 for the system block diagram of the invention, the radio signal relay 1 of the invention mainly consists of a receiver and transmitter 11, a signal processing unit 12, an input output bus unit 13, a processing unit 14, a memory unit 15, a signal amplification unit 16 and an antenna 17.

The receiver and transmitter 11 receives and transmits radio signals of communication or business equipment, and isolates the interference of different radio signals.

The signal processing unit 12 receives signals from the receiver and transmitter 11, and processes the signals, including signal amplification, error detection, signal transfer (for the received different radio signals), etc.

The input output bus unit 13 controls data transmission of various units in the radio signal relay 1. The data include data (signals) received in the communication or business equipment and the radio signal relay 1.

The processing unit 14 controls and coordinates operations of various units in the radio signal relay 1, and performs multiplex processing for the signals.

The memory unit 15 stores various setting data and related programs for the radio signal relay 1, and temporarily stores data signals received from the communication or business equipment.

The signal amplification unit 16 processes the radio signals to be relayed in the radio signal relay 1, and furnishes the processed signals for rear end transmission.

The antenna 17 receives radio signals from different communication or business equipment, and transmits the relayed radio signals.

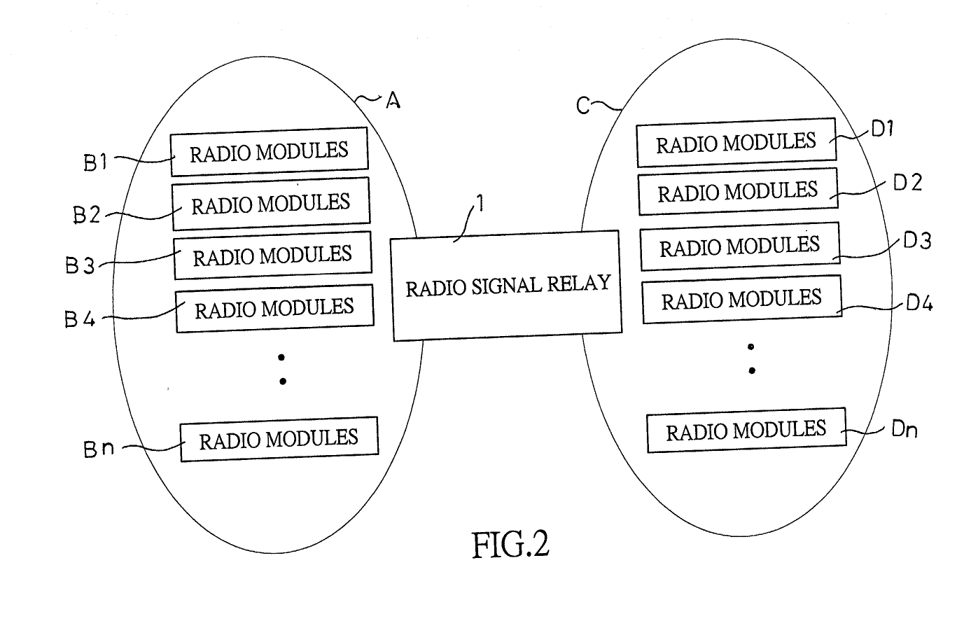

The radio signal relay 1 thus constructed may be adapted for use in various communication or business equipment (such as PDA, mobile phones, printers, display devices, wireless earphones, or other transmission devices, shown in FIG. 2). When in use, a desired number of the radio signal relays 1 are disposed at selected peripheral locations within the effective radio signal transmission peripheral boundary A (i.e. effective radio transmission distance) of the radio modules B1, B2, B3, B4 . . . Bn of various communication or business equipment. The invention can (theoretically) unlimitedly extend effective radio signal transmission coverage distance of different radio modules. For instance, as shown in FIG. 2, the radio modules B1, B2, B3, B4 . . . Bn of various communication or business equipment originally have an effective transmission distance boundary A. When the radio signal relay 1 of the invention is installed at a desired location, their effective transmission distance can be extended to another effective receiving/transmission distance boundary C of radio modules D1, D2, D3, D4 . . . , Dn of communication or business equipment located at another area. As a result, procurement quantity and costs of the communication or business equipment can be greatly reduced. This invention offers a common-sharing function and has the benefit of allowing many different radio signals to share a single relay.

The processing flow of the invention is elaborated as follows. Referring to FIGS. 1 and 2, radio signals transmitted from the radio module B1(B2, B3, B4 . . . Bn) of communication or business equipment are received by the receiver and transmitter 11 of the invention through the antenna 17. The received signals are processed (such as amplification, errors correction, etc.) by the signal processing unit 12. Then through the input output bus unit 13, the signal processing unit 12 transfers the received radio signals to the processing unit 14 for multiplexing processing, and retrieves corresponding radio signal data (such as amplification values, decrement values, etc.) from the memory unit for the relay 1 to make desired adjustments (such as amplify and re-transmit, etc.) for the radio signals. After the processing unit 14 retrieves the corresponding radio signal data from the memory unit, through the input output bus unit 13, transmits the originally received radio signals to the signal amplification unit 16 for processing. After processing, the signals are transmitted to the receiver and transmitter 11, and through the antenna 17, the originally received radio signals will be emitted. The emitted signals will be received by communication or business equipment D1 (D2, D3, D4 . . . , Dn) located at another area to complete relay process.

In summary, the present invention provides simple elements, has great common sharing capability, and can effectively resolve and integrate the effective transmission distance problem encountered in different radio signals, and overcomes the disadvantages of distance limitation in radio signal transmission.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

I claim:

1. A radio signal relay for integrating selected radio signals and extending transmission distances of the selected radio signals comprising a receiver and transmitter, a signal processing unit, an input output bus unit, a processing unit, a memory unit, a signal amplification unit and an antenna, wherein:
the receiver and transmitter receives and transmits the selected radio signals, and isolates the interference of non-selected radio signals;
the signal processing unit processes the signals received by the receiver and transmitter;
the input output bus unit controls data transmission among the units in the radio signal relay, the data including the received radio signals and data in the radio signal relay;.
the processing unit controls and coordinates operations of the units in the radio signal relay and performs multiplex processing for the signals;
the memory unit stores selected setting data and programs of the radio signal relay, and temporarily stores the received data signals;
the signal amplification unit processes the radio signals to be relayed in the radio signal relay and furnishes the processed signals for rear end transmitting; and
the antenna receives the selected radio signals and transmits the radio signals of the radio signal relay.

2. The radio signal relay of claim 1, wherein the signal processing unit performs signal amplification, error detection, and signal transfer for radio signals received from selected radio networks.
